(19) United States
(12) Patent Application Publication
(10) Pub. No.: US 2009/0226769 A1
(43) Pub. Date: Sep. 10, 2009

(54) MEASUREMENT OF INSULATION RESISTANCE OF FUEL CELL IN FUEL CELL SYSTEM

(75) Inventor: Masataka Ota, Aichi-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/915,674

(22) PCT Filed: May 25, 2006
(86) PCT No.: PCT/JP2006/310954

§ 371 Date: May 5, 2008

(30) Foreign Application Priority Data
May 27, 2005 (JP) 2005-155604

(51) Int. Cl. H01M 8/04

(52) U.S. Cl. 429/13; 429/23

(57) ABSTRACT

A fuel cell system includes a fuel cell, an insulation resistance measuring unit configured to measure insulation resistance between the fuel cell and an external conductor, and a control unit configured to control power generation status of the fuel cell. The insulation resistance measuring unit performs measurement of the insulation resistance under a condition in which the control unit maintains the fuel cell in a stable state such that fluctuation of output voltage of the fuel cell is within a predetermined permissible range.

### TECHNICAL FIELD

The present invention relates to technology for measuring insulation resistance of a fuel cell in a fuel cell system

### BACKGROUND ART

In a water-cooled fuel cell system in which the fuel cells are cooled by a circulating coolant, the electrical conductivity of the coolant rise over time due to ions eluting into the coolant. As the electrical conductivity of the coolant reaches a certain level, there is a risk that the electrical current generated by the fuel cells flows through the coolant and that the electrical power generated by the fuel cells cannot be drawn effectively. Moreover, if the coolant is decomposed by the electric current flowing through the coolant, there is a risk that heat transfer to the coolant is impaired by bubbles formed within the coolant flow passages and that cooling of the fuel cell becomes insufficient. For this reason, a conventional practice for preventing the various problems associated with increased conductivity of the coolant has been to monitor the rise in conductivity of the coolant in terms of the insulation resistance of the fuel cell, and to replace either the ion filter that removes the ions, or the coolant itself, when needed.

However, if the output voltage of a fuel cell fluctuates during measurement of the insulation resistance of the fuel cell, errors in insulation resistance measurements may occur and false detection of rising in conductivity may result, for example, in instances where rise in conductivity of the coolant is undetected or where a rise in conductivity of the coolant is detected despite no actual rise in conductivity having occurred. Such problems are particularly notable in a water-cooled fuel cell system in which rise in conductivity is detected via insulation resistance, but are nevertheless problems common to all manner of fuel cell systems that detect problems in the fuel cell system, such as electrical leakage, by measuring insulation resistance.

### DISCLOSURE OF THE INVENTION

To achieve at least part of the above mentioned object, a fuel cell system of the present invention is provided. The fuel cell system has a fuel cell; an insulation resistance measuring unit configured to measure insulation resistance between the fuel cell and an external conductor; and a control unit configured to control power generation status of the fuel cell, wherein the insulation resistance measuring unit performs measurement of the insulation resistance under condition in which the control unit maintains the fuel cell in a stable state such that fluctuation of output voltage of the fuel cell is within a predetermined permissible range.

With this arrangement, measurement of insulation resistance is carried out in a steady state in which fluctuation of output voltage that may cause insulation resistance measurement error lies within a predetermined permissible range. As a result, the accuracy of measurement of insulation resistance can be improved further.

The present invention may be reduced to practice in various modes, for example, an insulation resistance measurement device and measurement method in a fuel cell system; a control device and control method for such a measurement device; a fuel cell employing such devices and methods; or an electric car having on-board a generator device utilizing such a fuel cell system and the fuel cell thereof.

### BRIEF DESCRIPTION OF THE DRAWINGS

FIG. 1 is a schematic diagram of an electric car 10 as an embodiment of the present invention.

FIG. 2 is an illustration depicting measurement of insulation resistance of the fuel cell 100 by the insulation resistance measuring unit 340.

FIG. 3 is a flowchart of the fuel cell 100 insulation resistance measuring routine in the First Embodiment.

FIG. 4(a) through FIG. 4(e) are illustrations showing change over time in operating status of the fuel cell 100 in the First Embodiment.

FIG. 5 is a flowchart of the fuel cell 100 insulation resistance measurement routine in the Second Embodiment.

FIG. 6(a) through FIG. 6(e) are illustrations showing operation in the output suspending mode of a fuel cell that is experiencing cross leakage.

FIG. 7 is an illustration showing the relationship of output current I_{FC} and output voltage V_{FC} of the fuel cell 100 before and after initiation of charging control.

FIG. 8 is a flowchart of the fuel cell 100 insulation resistance measurement routine in the Third Embodiment.

### BEST MODE FOR CARRYING OUT THE INVENTION

The best mode for carrying out the present invention is described in the following order.

### A. First Embodiment:

### B. Second Embodiment:

### C. Third Embodiment:

### D. Variations:

### A. First Embodiment

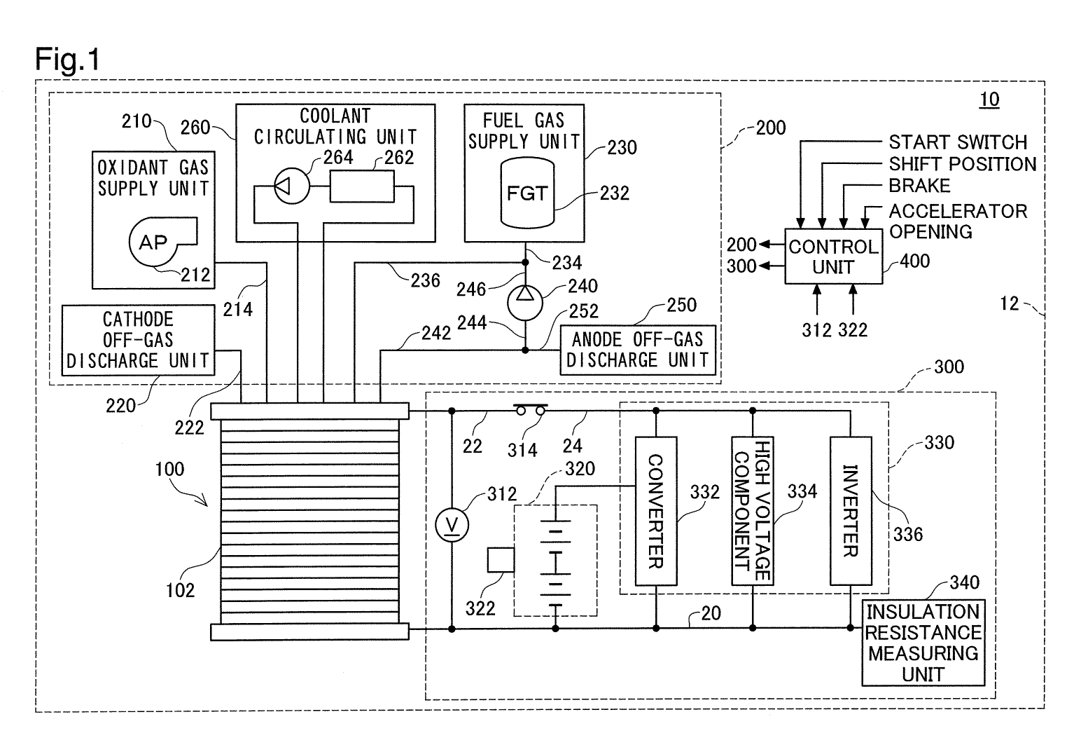

FIG. 1 is a schematic diagram of an electric car 10 as an embodiment of the present invention. The electric car 10 has a fuel cell 100, a fluid unit 200, a power unit 300, and a control unit 400. The fuel cell 100 is composed of a plurality of stacked cells 102. The fuel cell 100, the fluid unit 200, the power unit 300, and the control unit 400 are installed on the car body 12 of the electric car 10, which serves as an external conductor.

The fluid unit 200 includes an oxidant gas supply unit 210, a cathode off-gas discharge unit 220, a fuel gas supply unit 230, a circulating pump 240, an anode off-gas discharge unit 250, and a coolant circulating unit 260.

The oxidant gas supply unit 210 has an air pump 212. This air pump 212 produces compressed air from the outside air. The compressed air so produced is supplied, via an oxidant gas supply line 214, to the fuel cell 100 as the oxidant gas containing oxygen for use by the fuel cell 100. The oxidant gas supplied to the fuel cell 100 is delivered to the cathodes of in cells 102 that make up the fuel cell 100. At the cathode, the oxygen contained in the oxidant gas is consumed by the fuel cell reaction. The oxidant gas of reduced concentration of oxygen due to the fuel cell reaction (in general such a gas is called as “cathode off-gas”) is discharged from the fuel cell 100 to the cathode off-gas discharge unit 220, via a cathode off-gas discharge line 222. The cathode off-gas discharge unit 220 releases the cathode off-gas from the fuel cell 100 into the atmosphere.

The fuel gas supply unit 230 has a fuel gas tank 232. This fuel gas tank 232 is filled with hydrogen gas used as the fuel gas. The hydrogen gas filling the fuel gas tank 232 is pressure-regulated by a pressure reduction device (not shown) provided to the fuel gas supply unit 230. The pressure-regulated hydrogen gas is then supplied via a first fuel gas supply line 234 to a second fuel gas supply line 236. The second fuel gas supply line 236 is also supplied with anode off-gas as discussed later, with the hydrogen gas being mixed with the anode off-gas and supplied to the fuel cell 100.

The fuel gas supplied to the fuel cell 100 is delivered to the anodes in the cells 102. At the anode, the hydrogen contained in the fuel gas is consumed by the fuel cell reaction. The fuel gas of reduced concentration of hydrogen due to the fuel cell reaction (in general such a gas is called as “anode off-gas”) is supplied to the circulating pump 240 via a first anode off-gas discharge line 242 and a first return line 244. The circulating pump 240 then returns the anode off-gas to the second fuel gas supply line 236 via a second return line 246. By returning the anode off-gas using the circulating pump 240, the fuel gas is circulated through the second fuel gas supply line 236, the fuel cell 100, the first anode off-gas discharge line 242, the first return line 244, the circulating pump 240, and the second return line 246.

The anode off-gas discharge unit 250 is connected to the first anode off-gas discharge line 242 via a second anode off-gas discharge line 252. When the impurity concentration of the circulating fuel gas has reached a certain level, the anode off-gas discharge unit 250 will release the anode off-gas into the atmosphere as needed. At this time, the anode off-gas discharge unit 250 carries out a deactivation process by combusting the hydrogen contained in the anode off-gas.

The coolant circulating unit 260 has a radiator 262 and a coolant pump 264. The coolant pump 264 supplies coolant to the fuel cell 100. As the coolant supplied to the fuel cell 100 flows through the coolant flow passages provided within the fuel cell 100, the coolant absorbs the heat produced by the fuel cell reaction from the cells 102. The coolant, which is at elevated temperature having absorbed the heat, is then supplied to the radiator 262. The coolant supplied to the radiator 262 drops in temperature through radiation of heat into the atmosphere. The coolant whose heat has been radiated by the radiator 262 is supplied to the coolant pump 264, whereby the coolant is circulated between the coolant circulating unit 260 and the fuel cell 100.

Ions elute into the circulating coolant from the walls of the coolant flow passages. Thus, the ion concentration of the coolant will increase over time, and the electrical conductivity of the coolant rises. During this time that the coolant flows through the coolant flow passages within the fuel cell 100, it comes into contact with the cells 102 that make up the fuel cell 100. As the conductivity of the coolant contacting the cells 102 rises, the electrical current generated by the cells 102 flows through the coolant, so that the power generated by the cells 102 can no longer be drawn effectively. Moreover, if the coolant is decomposed by the electrical current flowing through the coolant, there is a risk that transfer of the heat produced by the cells to the coolant is impaired by bubbles formed within the coolant flow passages and that cooling of the fuel cell 100 becomes insufficient.

The coolant contacts both the cells 102 of the fuel cell 100 and the radiator 262. Since the radiator 262 is typically connected electrically to the car body 12, as the conductivity of the coolant rises, the insulation resistance between the fuel cell 100 and the car body 12 falls. Accordingly, the First Embodiment is configured so as to detect a decline in insulation resistance between the fuel cell 100 and the car body 12 (hereinafter termed simply “insulation resistance”), and detect a rise in conductivity of the coolant.

The power unit 300 includes a DC voltmeter 312, an output switch 314, a secondary cell 320, a high voltage load 330, and an insulation resistance measuring unit 340. The high voltage load 330 has a converter 332, a high voltage component 334, and an inverter 336.

The fuel cell 100 is connected to two lines 20, 22 provided to the power unit 300. The DC voltmeter 312, which measures the output voltage of the fuel cell 100, is connected between the two lines 20, 22. The line 22 connected to the fuel cell 100 is connected to a line 24 via the output switch 314. Between the line 20 and the line 24 are parallel-connected the converter 332, to which the converter 332 is connected; the high voltage component 334; and the inverter 336.

A remaining capacity monitor 322 for detecting the remaining capacity of the secondary cell 320 is provided to the secondary cell 320. As the remaining capacity monitor 322, it is possible to use, for example, a voltage sensor or an SOC meter that cumulates charge/discharge current in the secondary cell 320 over time.

The converter 332 converts the voltage of the secondary cell 320 and set a target voltage Vt across the line 22 and the line 24. With the output switch 314 connected (the ON state), the output current of the fuel cell 100 is regulated to the set voltage Vt across the line 22 and the line 24 set by the converter 332. The connected state of the output switch 314 and control of the output current of the fuel cell 100 will be discussed later.

The high voltage component 334 uses the power supplied via the two lines 22, 24 without voltage conversion. The high voltage component 334 includes, for example, motors (not shown) for respectively driving the air pump 212, the circulating pump 240, and the coolant pump 246, as well as the air conditioning unit provided to the electric car 10.

The inverter 336 converts the DC power supplied to the inverter 336 via the two lines 22, 24 to three-phase AC power, and supplies the converted power to the motor (not shown). The motor generates driving power for the electric car 10 using the power supplied by the inverter 336.

The high voltage component 334 and the inverter 336 constitute the load of the fuel cell system composed of the fuel cell 100, the fluid unit 200, the power unit 300, and the control unit 400.

The insulation resistance measuring unit 340 is connected on the line 20 of the power unit 300. The insulation resistance measuring unit 340 measures insulation resistance between the fuel cell 100 and the car body 12. Measurement of insulation resistance by the insulation resistance measuring unit 340 will be discussed later.

The control unit 400 is configured as a microcomputer equipped with a CPU, ROM, RAM, a timer, and so on. The control unit 400 acquires various types of signals such as output signals from the DC voltmeter 312 and the remaining capacity monitor 322; ON/OFF signals from the start switch of the electric car 10; and control signals for shift position and accelerator opening of the electric car. Various control processes are executed on the basis of these signals, and drive signals are output to the various components that make up the fluid unit 200 and the power unit 300.

The control unit 400 acquires the insulation resistance measurement output by the insulation resistance measuring unit 340. In the event that the acquired insulation resistance measurement is smaller than a predetermined minimum value for insulation resistance, it will be determined that coolant conductivity has risen. In the event of a determination that coolant conductivity has risen, the control unit 400 displays an alert prompting replacement of the coolant on the display panel (not shown) of the electric car 10.

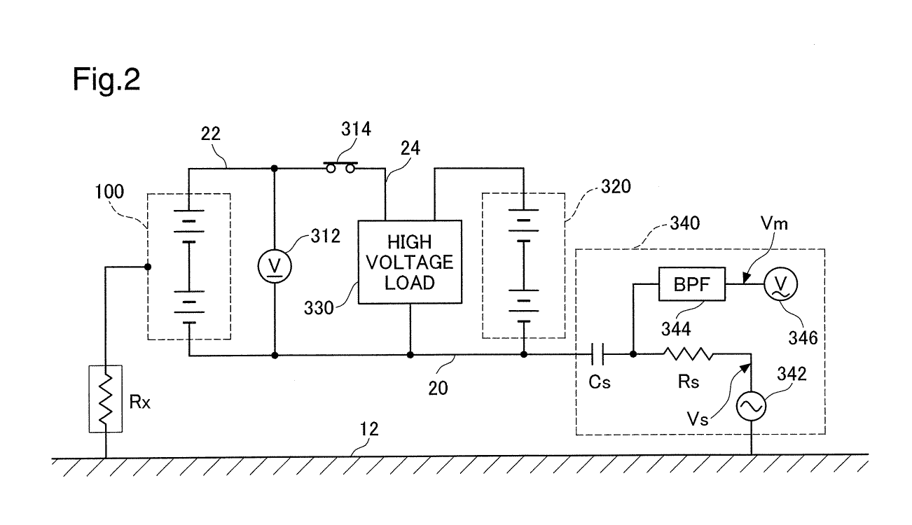

FIG. 2 is an illustration depicting measurement of insulation resistance of the fuel cell 100 by the insulation resistance measuring unit 340. The circuit shown in FIG. 2 is equivalent to a circuit composed of the fuel cell 100 and the power unit 300 shown in FIG. 1. In FIG. 2, insulation resistance between the fuel cell 100 and the electric car 10 (FIG. 1) is shown as simple insulation resistance Rx.

The insulation resistance measuring unit 340 includes an AC power supply 342, a sensing resistor Rs, a capacitor Cs, a band-pass filter (BPF) 344, and an AC voltmeter 346. The band-pass filter 344 is a band-pass filter having a center frequency equal to the oscillation frequency of the AC power supply 342. Noise reaching the AC voltmeter 346 is reduced by this band-pass filter 344.

As is apparent from FIG. 2, in the event that impedance of the capacitor Cs is sufficiently low at the oscillation frequency fs of the AC power supply 342 and the output voltage of the fuel cell 100 does not fluctuate, the resistance value Rx of insulation resistance can be derived from the measured signal voltage Vs of the AC power supply 342, the sensed voltage Vm by the AC voltmeter 346, and the resistance value Rs of sensing resistor, using the following expression.

Rx=Rs×Vm/(Vs−Vm) (1)

The resistance value Rs of sensing resistor and the measured signal voltage Vs of the AC power supply 342 are pre-established values. Thus, the resistance value Rx of insulation resistance can be computed from the sensed voltage Vm by the AC voltmeter 346.

When the output voltage of the fuel cell 100 fluctuates, the voltage on the line 20 fluctuates in response to the fluctuation in output voltage. Where the voltage fluctuation on the line 20 includes an AC component of frequency close to the oscillation frequency fs of the AC power supply 342 (hereinafter simply called the “AC component”), the AC component of the voltage on the line 20 passes through the band-pass filter 344 and reaches the AC voltmeter 346. If the AC component of the voltage on the line 20 is applied to the AC voltmeter 346 in this way, the sensed voltage Vm fluctuates, and the resistance value of calculated insulation resistance differs from the actual resistance value Rx. Accordingly, in the First Embodiment, measurement of insulation resistance is carried out in condition with the fuel cell 100 maintained in a stable state wherein fluctuation of the output voltage V_{FC} of the fuel cell 100 remains within a predetermined permissible range. The predetermined permissible range for fluctuation of the output voltage V_{FC} can be calculated with reference to the configuration of the insulation resistance measuring unit 340 and the value of sensed insulation resistance, in such a way as to inhibit insulation resistance measurement error caused by the AC component of the output voltage V_{FC}.

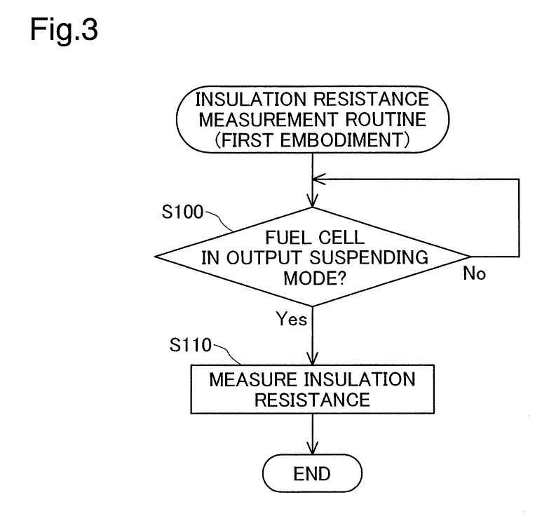

FIG. 3 is a flowchart of the fuel cell 100 insulation resistance measuring routine in the First Embodiment. This insulation resistance measuring routine is executed at predetermined intervals during operation of the electric car 10, for example.

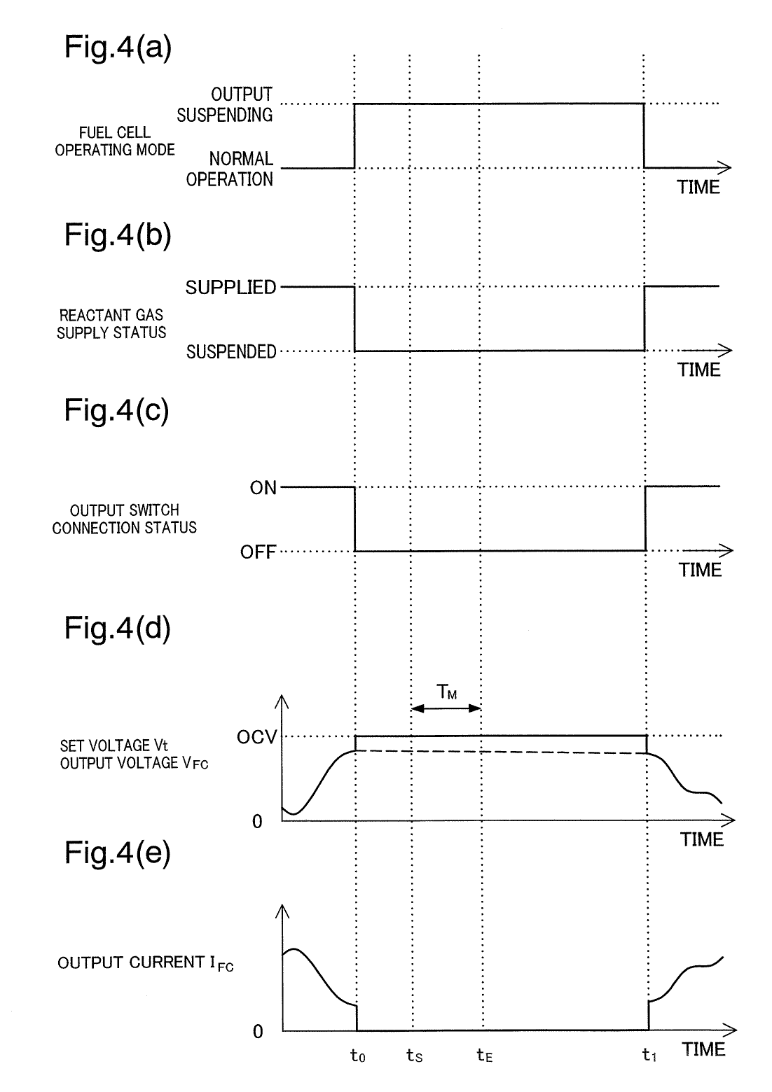

FIG. 4(a) through FIG. 4(e) are illustrations showing change over time in operating status of the fuel cell 100 in the First Embodiment. The horizontal axis of each of the graphs shown in FIG. 4 represents time. The vertical axis of the graph in FIG. 4 (a) represents the operating mode of the fuel cell 100. The vertical axis of the graph in FIG. 4 (b) represents supply status of oxidant gas and fuel gas (hereinafter collectively referred to as “reactant gases”) to the fuel cell 100. The vertical axis of the graph in FIG. 4 (c) represents the connection status of the output switch 314 (FIG. 1). The solid line in the graph of FIG. 4 (d) indicates temporal change in the output voltage V_{FC} of the fuel cell 100, and the broken line indicates the set voltage Vt between the two lines 22, 24 (FIG. 1) set by the converter 332 (FIG. 1). The vertical axis of the graph in FIG. 4 (e) represents the output current I_{FC} of the fuel cell 100.

In Step S100 of FIG. 3, the control unit 400 determines whether the fuel cell 100 is operating in an output suspending mode (described later) associated with stable output voltage. If the controller determines that operating mode of the fuel cell 100 is not the output suspending mode, control is returned to Step S100. Step S100 is subsequently repeated until the operating mode of the fuel cell 100 goes to the output suspending mode.

In the example of FIG. 4(a) through FIG. 4(e), the fuel cell 100 is operating in normal operating mode prior to time to. As shown in FIG. 4 (b), in normal operating mode, the reactant gases are supplied to the fuel cell 100. As shown in FIG. 4 (c), the output switch 314 at this time is maintained in the ON state, supplying the power generated by the fuel cell 100 to the high voltage load 330 (FIG. 1). Since the output switch 314 is in the ON state, the output voltage V_{FC} of the fuel cell 100 is equivalent to the set voltage Vt set by the converter 332. This set voltage Vt is regulated according to the power requirements of the high voltage load 330. As shown in FIGS. 4 (d) and (e), the output current I_{FC} of the fuel cell 100 declines in association with higher output voltage V_{FC}, and rises in association with lower output voltage V_{FC}.

With the fuel cell 100 in normal operating mode in this way, there is a risk of error in measurement of insulation resistance, caused by fluctuation of the output voltage V_{FC} of the fuel cell 100. Accordingly, in the First Embodiment, since Step S100 of FIG. 3 is executed repeatedly, measurement of insulation resistance of the fuel cell 100 is not executed until the fuel cell 100 goes into the output suspending mode.

In the example of FIG. 4(a) through FIG. 4(e), next, the operating status of the fuel cell 100 switches from normal operating mode to the output suspending mode at time to. Then, from time to time t₁, the operating status of the fuel cell 100 is maintained in the output suspending mode. Operation of the fuel cell 100 in the output suspending mode takes place, for example, in the event that the secondary cell 320 (FIG. 1) has high remaining capacity and the power requirement of the high voltage load 330 is low.

The output suspending mode is an operating mode of the fuel cell 100 wherein, with the fuel cell system running, power generation by the fuel cell 100 is suspended temporarily. During operation in the output suspending mode, the control unit 400 and the high voltage load 330 are kept running through power supplied by the secondary cell 320. Operation of the fuel cell 100 in this output suspending mode is also typically referred to as intermittent operation.

As shown in FIG. 4 (b), in the output suspending mode, the supply of reactant gases to the fuel cell 100 is suspended. Specifically, the control unit 400 suspends driving of the air pump 212 (FIG. 1) and the circulating pump 240 (FIG. 1), as well as suspending the supply of hydrogen gas from the fuel gas supply unit 230, and discharge of anode off-gas to the outside from the anode off-gas discharge unit 250. In addition to suspending the supply of reactant gases, the control unit 400 turns the output switch 314 to OFF. With output switch 314 in the OFF state, the output current I_{FC} of the fuel cell 100 goes to zero, so the output voltage V_{FC} of the fuel cell 100 goes to open circuit voltage OCV. In the event that the fuel cell 100 is not in operation during the output suspending mode, the converter set the set voltage Vt, for example, to the voltage at the terminals of the secondary cell 320, so as to avoid loss in the power unit 300.

As shown by the flowchart in FIG. 3, when the fuel cell 100 is in the output suspending mode, control passes from Step S100 to Step S110. In Step S110, the control unit 400 issues an instruction to the insulation resistance measuring unit 340, to begin measuring insulation resistance. Once measurement of insulation resistance has been completed, the insulation resistance measurement routine shown in FIG. 3 terminates.

In the example of FIG. 4(a) through FIG. 4(e), measurement of insulation resistance begins at time t_{S}. Measurement of insulation resistance continues for a predetermined time interval T_{M} (e.g. 30 seconds) in order to suppress error caused by noise or other factors. During the period from time t_{S} to time t_{E} (t_{S}+T_{M}) the output switch 314 is in the OFF state, so the output voltage V_{FC} of the fuel cell 100 is maintained substantially at open circuit voltage OCV. Thus, error in measurements of insulation resistance caused by fluctuation in the output voltage V_{FC} of the fuel cell 100 can be suppressed.

In the example of FIG. 4 (a) through FIG. 4(e), the operating status of the fuel cell 100 is switched from the output suspending mode to the normal operating mode at time t₁. As shown in FIG. 4 (b), at this time, the control unit 400 resumes supply of the reactant gases to the fuel cell 100. Together with resumption of supply of the reactant gases, the control unit 400 places the output switch 314 in the ON state. When the output switch 314 assumes the ON state, the output voltage V_{FC} of the fuel cell 100 rises to the set voltage Vt set by the converter 332. Beginning at time t₁, the output current I_{FC} of the fuel cell 100 changes in response to changes in the output voltage V_{FC}, in the same way as prior to time t₀.

In this way, in the First Embodiment, measurement of insulation resistance of the fuel cell 100 takes place during an interval in which the operating status of the fuel cell 100 is the output suspending mode. For the interval of the output suspending mode, the output voltage V_{FC} of the fuel cell 100 is substantially at open circuit voltage OCV. Thus, error in insulation resistance measurements caused by fluctuation of the output voltage V_{FC} of the fuel cell 100 can be suppressed.

### B. Second Embodiment

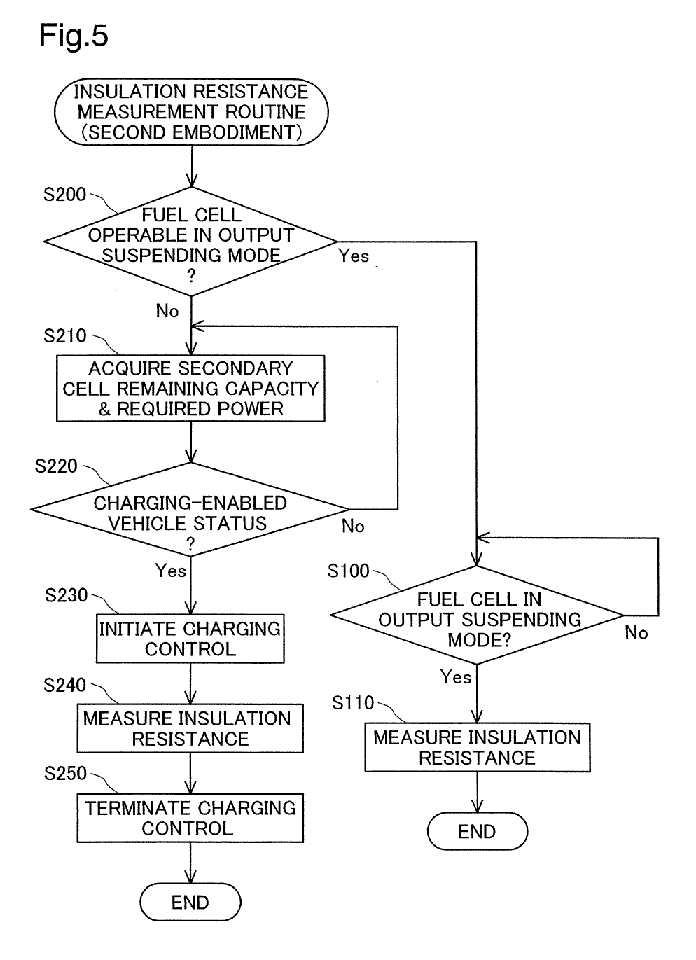

FIG. 5 is a flowchart of the fuel cell 100 insulation resistance measurement routine in the Second Embodiment. The insulation resistance measurement routine of the Second Embodiment shown in FIG. 5 differs from the insulation resistance measurement routine of the First Embodiment shown in FIG. 3, in that there is an additional Step S200 for determining whether the fuel cell 100 is operable in the output suspending mode and Steps S210 to S250 for measuring insulation resistance in an operating status other than the output suspending mode.

In Step S200, the control unit 400 determines whether the fuel cell 100 is operable in the output suspending mode. In the event of a determination that the fuel cell 100 is operable in the output suspending mode, control passes to Step S100. Insulation resistance is then measured in the output suspending mode, in the same manner as in the First Embodiment. On the other hand, if it is determined that the fuel cell 100 is not operable in the output suspending mode, control passes to Step S210.

The determination as to whether the fuel cell 100 is operable in the output suspending mode is made by determining whether the drop in the output voltage V_{FC} of the fuel cell 100 observed during the fuel cell 100 is operated for a predetermined length of time under conditions identical to those during execution of the output suspending mode exceeds a certain predetermined limit. In the event that the drop in output voltage V_{FC} exceeds the predetermined limit, there is risk of damage to the fuel cell 100, the fluid unit 200, and/or the power unit during switching from the output suspending mode to normal operating mode. Therefore it is determined that the cell should not be operated in the output suspending mode. An example of a fuel cell that should not be operated in the output suspending mode is a fuel cell 100 whose electrolyte membrane has deteriorated to the point that there is leakage of hydrogen from the anode to the cathode (cross leakage).

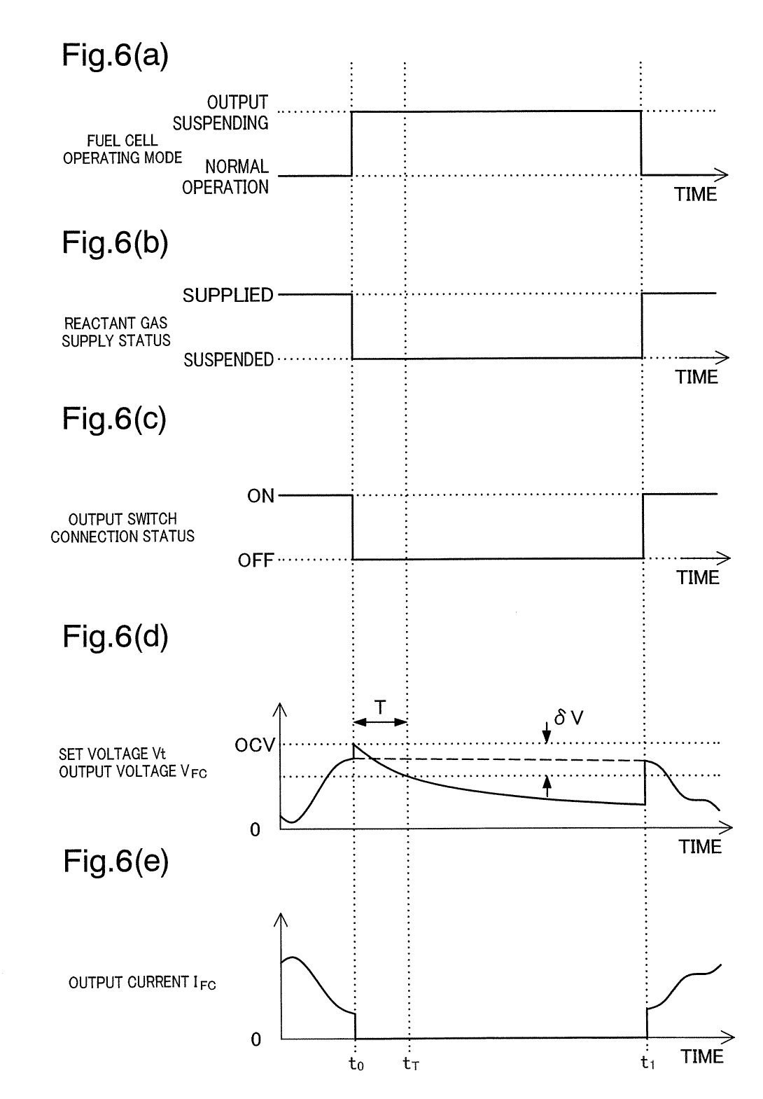

FIG. 6(a) through FIG. 6(e) are illustrations showing operation in the output suspending mode of a fuel cell that is experiencing cross leakage. FIG. 6(a) through FIG. 6(e) differ from FIG. 4(a) through FIG. 4(e) in that the temporal change in the output voltage V_{FC} shown by the solid line in FIG. 6 (d) differs from the temporal change in the output voltage V_{FC} shown by the solid line in FIG. 4 (d). In other respects it is the same as FIG. 4(a) through FIG. 4(e).

As mentioned above, in the output suspending mode, the air pump 212 (FIG. 1) is stopped, suspending the supply of oxidant gas to the fuel cell 100. When the supply of oxidant gas is suspended, hydrogen leaking from the anode to the cathode due to cross leakage collects on the cathode side of the electrolyte membrane. As hydrogen collects on the cathode side of the electrolyte membrane, the oxygen concentration declines on the cathode side of the electrolyte membrane and the output voltage V_{FC} of the fuel cell drops below the open circuit voltage OCV.

In the example of FIG. 6(a) through FIG. 6(e), the output voltage V_{FC} of the fuel cell drops gradually beginning at the time to of switching from the normal operating mode to the output suspending mode. Then, at the time t₁ of switching from the output suspending mode to the normal operating mode, the output voltage V_{FC} goes to lower voltage than the set voltage Vt set by the converter 332. When the output switch 314 is switched ON with the output voltage V_{FC} lower than the set voltage Vt in this way, reverse current flows into the fuel cell, and there is a possibility that the fuel cell is damaged by the reverse current.

Accordingly, in the Second Embodiment, there is executed a inspecting mode in which the supply of reactant gases is suspended and the output switch 314 is turned OFF, in the same manner as when the output suspending mode is executed. Then, using the DC voltmeter 312 (FIG. 1), the output voltage V_{FC} is measured at a point in time after a predetermined time interval T has elapsed from the start of the inspecting mode. In the event that the difference between the output voltage V_{FC} and the open circuit voltage OCV, this difference being equivalent to the drop in the output voltage V_{FC} from the start of the inspecting mode, is greater than a certain predetermined limit δV, it is determined that the fuel cell should not be operated in the output suspending mode. Then, after the predetermined time interval T has elapsed since start of the inspecting mode, the fuel cell is switched from the inspecting mode back to the normal operating mode. The predetermined time interval T and the predetermined limit δV may be established appropriately from experimentally-derived values so as to enable determination as to operability in the output suspending mode, and to avoid any damage to the fuel cell etc. when determining the operability in the output suspending mode.

In Step S210 of FIG. 5, the control unit 400 acquires the remaining capacity of the secondary cell 320 (FIG. 1) and the power requirement of the high voltage load 330 (FIG. 1), respectively. The remaining capacity of the secondary cell 320 is acquired by reading the output signal of the remaining capacity monitor 322. The power requirement is calculated from the control signals for shift position, accelerator opening, etc. of the electric car 10.

In Step S220, on the basis of the acquired secondary cell 320 remaining capacity and the power requirement of the high voltage load 330, the control unit 400 determines whether charging of the secondary cell 320 is possible given the current status of the electric car 10. Specifically, in the event that the remaining capacity of the secondary cell 320 is smaller than a predetermined threshold for remaining capacity and the power requirement of the high voltage load 330 is greater than a predetermined threshold for power, it is determined that charging is not possible. In the event of a determination that charging of the secondary cell 320 is not possible, control returns to Step S210, and Steps S210 and S220 are repeated until charging of the secondary cell 320 becomes possible. On the other hand, in the event of a determination that charging of the secondary cell 320 is possible, control passes to Step S230.

In Step S230, the control unit 400 initiates control for charging the secondary cell 320 (charging control). Specifically, the output current I_{FC} of the fuel cell 100 is increased by setting the set voltage Vt set by the converter 332 (FIG. 1) to a level lower than a target voltage set with reference to the power requirement of the high voltage load 330. By reducing the set voltage Vt in this way, the fuel cell 100 outputs power in excess of the level of power required by the high voltage load 330, and this extra power can be used to charge the secondary cell 320.

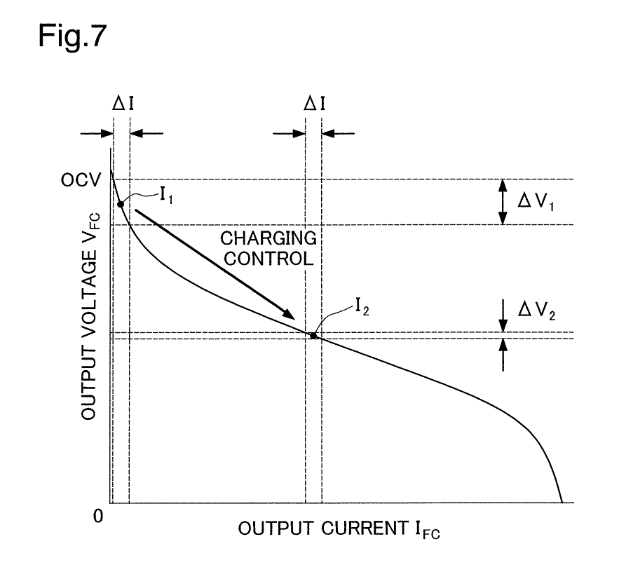

FIG. 7 is an illustration showing the relationship of output current I_{FC} and output voltage V_{FC} of the fuel cell 100 before and after initiation of charging control. A chargeable state is a state in which the power requirement of the high voltage load 330 is smaller than the predetermined power threshold, and thus in the state prior to initiating charging control, the output current I_{FC} will be low current I₁. At this time, if the power requirement of the high voltage load 330 fluctuates and the output current I_{FC} fluctuates by ΔI, the output voltage V_{FC} fluctuates by ΔV₁.

When charging control is executed and electrical current for charging the secondary cell 320 is drawn, the output current I_{FC} rises and reaches a current value I₂. In this state, if the output current I_{FC} fluctuates by ΔI, the output voltage V_{FC} fluctuates by ΔV₂ which is smaller than the ΔV₁ observed prior to charging control. In this way, as the output current I_{FC} increases through execution of charging control, fluctuation of output voltage with respect to a given fluctuation ΔI of the output current declines from ΔV₁ to ΔV₂.

In Step S240 of FIG. 5, the control unit 400 begins to measure insulation resistance. As mentioned above, variation of the output voltage V_{FC} with respect to variation of the output current I_{FC} becomes smaller. Thus, error in the insulation resistance measurements taken in Step S230 is smaller than errors in the absence of charging control. Moreover, in Step S240, since charging control continues until measurement of insulation resistance has been completed, it is preferable for the upper limit of remaining capacity for halting charging of the secondary cell 320 to be higher than that in the normal state. Furthermore, of components of the high voltage component 334 (FIG. 1), it is preferable to halt operation of those components which it is possible to do so, in order to reduce the fluctuation ΔI of the output current.

In Step S250, the control unit 400 terminates execution of charging control. Execution of charging control is terminated by setting the set voltage Vt set by the converter 332 to a value established with reference to the power requirement of the high voltage load 330. Then, after Step S250, the insulation resistance measurement routine terminates.

In this way, in the Second Embodiment as well, fluctuation of the output voltage V_{FC} in association with fluctuation of the output current I_{FC} are suppressed. Thus, error in insulation resistance measurements caused by fluctuation of the output voltage V_{FC} can be suppressed.

The Second Embodiment is preferable to the First Embodiment in that error in insulation resistance measurements can be reduced even in instances where it would be undesirable to operate the fuel cell 100 in the output suspending mode. On the other hand, the First Embodiment is preferable to the Second Embodiment in that control for the purpose of measuring insulation resistance is easier.

In the Second Embodiment, the determination as to possibility of charging control is made on the basis of both the remaining capacity of the secondary cell 320 and the power requirements of the high voltage load 330. It is also possible to determine whether charging control is possible on the basis of the remaining capacity of the secondary cell 320 only, for example. In this case as well, it is possible, by carrying out charging control, to reduce fluctuation of the output voltage V_{FC} in association with fluctuation of the output current I_{FC}, and thus error in insulation resistance measurements can be suppressed.

Moreover, whereas in the Second Embodiment, insulation resistance is measured with the fuel cell 100 in operation in the output suspending mode in instances where the fuel cell is operable in the output suspending mode. It is also possible to measure insulation resistance while carrying out charging control by default, without making a determination as to whether the fuel cell 100 is operable in the output suspending mode. With this approach as well, fluctuation of the output voltage V_{FC} in association with fluctuation of the output current I_{FC} will be suppressed so that error in insulation resistance measurements caused by fluctuation of the output voltage V_{FC} can be suppressed.

In the Second Embodiment, the output current I_{FC} of the fuel cell 100 is increased by executing charging control, in order to set the output current I_{FC} in an electrical current range such that the level of change in output voltage relative to the level of change in output current is small. Other methods to increase the output current I_{FC} may also be used. For example, it is acceptable to increase the output current I_{FC} by running all of the components included in the high voltage component 334 (FIG. 1) in order to maximize power consumption by the high voltage component 334. In this manner as well it is possible to increase the output current I_{FC} and set the output current I_{FC} to within an electrical current range such that the level of change in output voltage relative to the level of change in output current is small.

Moreover, in the Second Embodiment, a inspecting mode is executed for determining whether the output suspending mode is executable. However, the inspecting mode may be omitted. In this case, the output voltage V_{FC} is measured during execution of the output suspending mode, and in the event that the difference between the output voltage V_{FC} and the open circuit voltage OCV becomes greater than a predetermined limit, execution of the output suspending mode is interrupted. After interrupting execution of the output suspending mode, measurement of insulation resistance is carried out while executing charging control.

### C. Third Embodiment

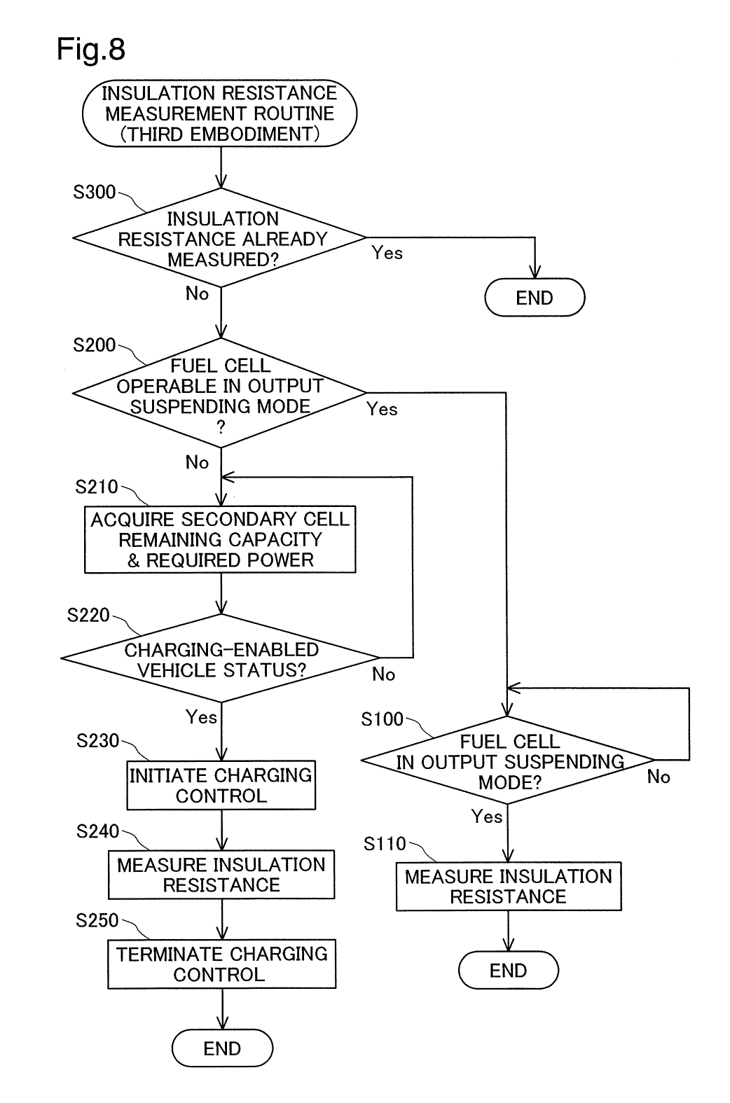

FIG. 8 is a flowchart of the fuel cell 100 insulation resistance measurement routine in the Third Embodiment. The insulation resistance measurement routine of the Third Embodiment shown in FIG. 8 differs from the insulation resistance measurement routine of the Second Embodiment shown in FIG. 5 in that there is an additional Step S300 preceding Step S200. In other respects, it is the same as the insulation resistance measurement routine of the Second Embodiment.

In Step S300, the control unit 400 determines whether insulation resistance has already been measured subsequent to startup of the fuel cell 100. In the event that insulation resistance has not been measured yet, control passes to Step S200 and insulation resistance is measured in the same manner as in the insulation resistance measurement routine of the Second Embodiment. If on the other hand insulation resistance has been measured already, the insulation resistance measurement routine shown in FIG. 8 terminates.

Specifically, when the power switch of the electric car 10 is turned from OFF to ON, the control unit 400 resets a flag indicating that insulation resistance measurement has taken place. Then, when insulation resistance is measured, the insulation resistance measurement flag is set. In Step S300, if the insulation resistance measurement flag is set, it is determined that insulation resistance measurement has taken place and the insulation resistance routine terminates.

In the Third Embodiment, insulation resistance is measured only once during the period from startup to shutdown of the electric car 10 (such a duration is called “one trip”). Since the conductivity of the coolant typically rises only gradually over time, measuring insulation resistance a single time during one trip may be sufficient to prevent damage caused by a rise in coolant conductivity.

Moreover, whereas in the Third Embodiment the insulation resistance measurement flag is reset when the power switch of the electric car 10 is turned from OFF to ON, the insulation resistance measurement flag may be reset at predetermined time intervals, at predetermined travel distance intervals, or at intervals after generation of a predetermined amount of power, for example. It will be possible to prevent damage caused by a rise in coolant conductivity in this way as well.

### D. Variations

The foregoing description of the present invention based on certain preferred embodiments is provided for illustration only and not for the purpose of limiting the invention, and various modifications such as the following can be made herein without departing from the scope of the invention.

### D1. Variation 1:

In the embodiments hereinabove, measurement of insulation resistance is carried out with the fuel cell maintained in a stable state by executing either the output suspending mode or charging control. In general, measurement of insulation resistance can be carried out in any stable state in which fluctuation of output voltage V_{FC} is kept within a predetermined permissible range. For example, such a stable state could be achieved by using power from the secondary cell 320 to compensate for fluctuation in power requirements and suppress fluctuation in output current I_{FC} of the fuel cell 100. As is apparent from the preceding description, stable states in which fluctuation of output voltage V_{FC} is within a predetermined permissible range refer to those including states in which output voltage V_{FC} does not fluctuate, such as a state where the fuel cell 100 is operating in the output suspending mode.

### D2. Variation 2:

In the embodiments hereinabove, a secondary cell 320 is used as the secondary power supply employed together with the fuel cell 100. Any rechargeable electrical storage device could be used as the secondary power supply. It is possible to use a capacitor as the electrical storage device.

### D3. Variation 3:

In the embodiments hereinabove, insulation resistance is measured between the fuel cell 100 and the car body 12 of the electric car 10 using the insulation resistance measurement technology of the present invention. The invention is also applicable generally to measurement of insulation resistance between the fuel cell 100 and a conductor disposed to the outside of the fuel cell 100 (external conductor). It is possible to employ the present invention for measuring insulation resistance between a metal unit of the radiator 262 (FIG. 1) and the fuel cell 100, for example.

### D4. Variation 4:

In the embodiments hereinabove, the insulation resistance measurement technology of the present invention is applied to a water-cooled fuel cell system. The insulation resistance measurement technology of the present invention can also be implemented in fuel cell systems that do not use coolant. In this case, electrical leakage from the fuel cell can be detected by detecting a drop in insulation resistance of the fuel cell.

### INDUSTRIAL APPLICABILITY

The present invention is applicable to measurement of insulation resistance in fuel cell systems employing fuel cells of various kinds.

1-10. (canceled)

11. A fuel cell system for supplying power to a load comprising:
a fuel cell;
an insulation resistance measuring unit configured to measure insulation resistance between the fuel cell and an external conductor; and
a control unit configured to control power generation status of the fuel cell, wherein
the insulation resistance measuring unit performs measurement of the insulation resistance under a condition in which the control unit maintains the fuel cell in a stable state such that fluctuation of output voltage of the fuel cell is within a predetermined permissible range.

12. The fuel cell system according to claim 11, wherein
the control unit includes an output suspending mode to suspend electrical current output from the fuel cell while maintaining output voltage of the fuel cell to a predetermined voltage greater than 0, and
the insulation resistance measuring unit measures the insulation resistance during execution of the output suspending mode by the control unit.

13. The fuel cell system according to claim 11, wherein
the insulation resistance is resistance between the fuel cell and the external conductor via fuel cell coolant.

14. The fuel cell system according to claim 12, wherein
the control unit suspends electrical current output from the fuel cell by setting the fuel cell in an open circuit state in which the fuel cell and the load are electrically disconnected.

15. The fuel cell system according to claim 14, wherein
the insulation resistance is resistance between the fuel cell and the external conductor via fuel cell coolant.

16. A fuel cell system for supplying power to a load comprising:
a fuel cell;
an insulation resistance measuring unit configured to measure insulation resistance between the fuel cell and an external conductor;
a control unit configured to control power generation status of the fuel cell; and
an electrical storage device, wherein
the control unit includes a load fluctuation compensating mode to compensate fluctuation of power supplied to the load and to keep the fuel cell in a stable state by charging or discharging the electrical storage device, and
the insulation resistance measuring unit measures the insulation resistance during execution of the load fluctuation compensating mode by the control unit.

17. The fuel cell system according to claim 16, wherein
the control unit includes an output suspending mode to suspend electrical current output from the fuel cell while maintaining output voltage of the fuel cell to a predetermined voltage greater than 0, and
the insulation resistance measuring unit measures the insulation resistance during execution of the output suspending mode by the control unit.

18. A fuel cell system for supplying power to a load comprising:
a fuel cell;
an insulation resistance measuring unit configured to measure insulation resistance between the fuel cell and an external conductor; and
a control unit configured to control power generation status of the fuel cell, wherein
the control unit includes an output current setting mode to control output current of the fuel cell within an outputtable current range of the fuel cell into a predetermined current range in which variation of output voltage with respect to variation of output current is small, and
the insulation resistance measuring unit measures the insulation resistance during execution of the output current setting mode by the control unit.

19. A fuel cell system for supplying power to a load comprising:
a fuel cell;
an insulation resistance measuring unit configured to measure insulation resistance between the fuel cell and an external conductor; and
a control unit configured to control power generation status of the fuel cell, wherein
the control unit includes:
an output suspending mode to suspend electrical current output from the fuel cell while maintaining output voltage of the fuel cell to a predetermined voltage greater than 0;
an inspecting mode in which the fuel cell is placed in a state identical to that during execution of the output suspending mode, but only for a predetermined time period shorter than a time period over which the output suspending mode is maintained; and
a measurement control mode different from the output suspending mode and executed to maintain the fuel cell in a stable state if a drop in output voltage of the fuel cell during execution of the inspecting mode exceeds a predetermined limit,
if the drop in output voltage of the fuel cell during execution of the inspecting mode does not exceed the predetermined limit, the insulation resistance measuring unit measures the insulation resistance during execution of the output suspending mode, and
if the drop in output voltage of the fuel cell during execution of the inspecting mode exceeds the predetermined limit, the insulation resistance measuring unit measures the insulation resistance during execution of the measurement control mode rather than in the output suspending mode.

20. The fuel cell system according to claim 19, further comprising an electrical storage device, wherein
the measurement control mode is a load fluctuation compensating mode to compensate fluctuation of power supplied to the load and to keep the fuel cell in the stable state by charging or discharging the electrical storage device.

21. The fuel cell system according to claim 19, wherein
the measurement control mode is an output current setting mode to control output current of the fuel cell within an outputtable current range of the fuel cell into a predetermined current range in which variation of output voltage with respect to variation of output current is small.

22. A fuel cell system for supplying power to a load comprising:
a fuel cell;
an insulation resistance measuring unit configured to measure insulation resistance between the fuel cell and an external conductor; and
a control unit configured to control power generation status of the fuel cell, wherein
the control unit includes:
an output suspending mode to suspend electrical current output from the fuel cell while maintaining an output voltage of the fuel cell to a predetermined voltage greater than 0; and
a measurement control mode different from the output suspending mode to maintain the fuel cell in a stable state,
if a drop in output voltage of the fuel cell during execution of the output suspending mode exceeds a predetermined limit, the control unit interrupts the output suspending mode and executes the measurement control mode,
if the drop in output voltage of the fuel cell during execution of the output suspending mode does not exceed the predetermined limit, the insulation resistance measuring unit measures the insulation resistance during execution of the output suspending mode, and
if the drop in output voltage of the fuel cell during execution of the output suspending mode exceeds a predetermined limit, the insulation resistance measuring unit measures the insulation resistance during execution of the measurement control mode rather than in the output suspending mode.

23. An insulation resistance measuring method for measuring insulation resistance between a fuel cell and an external conductor, comprising:
(a) controlling power generation status of the fuel cell so as to maintain the fuel cell in a stable state such that fluctuation of output voltage of the fuel cell is within a predetermined permissible range; and
(b) measuring the insulation resistance between the fuel cell and the external conductor during the fuel cell maintained in the stable state in step (a).
